(19) United States
(12) Patent Application Publication
(10) Pub. No.: US 2003/0032755 A1
(43) Pub. Date: Feb. 13, 2003

(54) Compositions containing polycarbonate and pigments

(76) Inventors: Rudiger Gorny, Krefeld (DE); Siegfried Anders, Koln (DE); Wolfgang Nising, Sankt Augustin (DE)

Correspondence Address: BAYER CORPORATION, PATENT DEPARTMENT, 100 BAYER ROAD, PITTSBURGH, PA, 15205, US

(21) Appl. No.: 10/203,677

(22) PCT Filed: Feb. 2, 2001
(86) PCT No.: PCT/EP01/01119

(30) Foreign Application Priority Data
Feb. 15, 2000 (DE) 100 06 651.8

(51) Int. Cl. C08G 18/00

(52) U.S. Cl. 528/44

(57) ABSTRACT

The invention relates to compositions containing a thermoplastic synthetic material and a multi-layered pigment, to a method for producing products containing said compositions and to products containing the compositions, in particular, to panels containing said compositions.

The present invention relates to compositions containing a thermoplastic material and a multi-layered pigment, as well as a process for producing articles containing these compositions as well as articles containing these compositions, in particular sheets containing these compositions.

Polycarbonate sheets are known, for example, from EP-A 0 110 221 and are supplied for a multitude of purposes. The production is carried out by extrusion of polycarbonate and optionally coextrusion with moulding compositions containing an increased proportion of UV absorbers.

For long-term protection against discoloration by UV light, EP-A 0 320 632 discloses that the sheets are to be provided with a coextrusion layer containing increased concentrations of relatively non-volatile UV absorbers. EP-A 0 678 376 discloses that for sheets made of polyester, in particular for sheets made of copolyesters of aromatic dicarboxylic acids and mixtures of two aliphatic diols such as, for example, ethylene glycol and cyclohexanedimethanol (PETG), protection against weathering is achieved by means of a coextrusion with top coats which contain UV absorbers, for example, based on benzotriazoles, in increased concentrations.

A plate of polymethyl methacrylate containing light-reflecting particles aligned parallel to the surface is known from the German Patent DE-C 25 44 245. Their layer thickness is calculated so as to ensure that they largely let through visible light and largely reflect infrared radiation.

The known composition contains the light-reflecting particles in the polymethyl methacrylate base material. They are introduced into the liquid methyl methacrylate monomer, this is packed into a polymerisation chamber formed from glass plates arranged in parallel and is then partially polymerised. Up to this point, the particles are sunk onto the lower glass plate. The particles are aligned parallel to the surface by means of a parallel displacement of this plate and are held in this position while the polymerisation continues. Owing to this treatment step, the production process is elaborate and costly.

EP-A 340 313 describes coverings which deflect solar radiation, for use on ships, tanks, buildings and the like, in order to lessen the extent to which they heat up in the sun. The coverings contain a binder, a heat-reflecting pigment and optionally coloured pigments of any type.

According to EP-A 428 937, polyethylene sheets for greenhouses are provided, by means of painting or spraying, with a covering which contains the light-reflecting pigments in a matrix consisting of a coating binder. As the pigment particles are not oriented as a result of the application process, they exert only a shading effect and result in an unsatisfactory transmission. Because of the low adhesion of conventional coating binders to polyethylene, the coating can easily be washed off the coated sheet by means of a water jet.

EP-A 0 548 822 describes PMMA sheets which contain special pigments in the coextrusion layer. These pigments consist of a substrate, for example, of mica, which is covered with a titanium dioxide layer.

EP-A 0 774 551 describes various types of coextruded polycarbonate sheets which can contain several coextrusion layers. Each individual coextrusion layer gives the sheet different functions. For exterior applications, it is important that the pigment-containing layer be covered with an overlying UV-protective layer, as the resistance of the pigments to weathering is unsatisfactory in polycarbonate. The overlying UV-protective layer thus protects the sheet from severe discoloration.

Multi-layer coextrusion is laborious and costly, as at least two different coextrusion moulding compositions have to be prepared and at least two coextruders have to be connected to the main extruder.

The object of the present invention, accordingly, is to provide compositions which permit the production of articles having pearl-like surfaces.

The object of the present invention is also the provision of articles made of these compositions.

The object of the invention is achieved by compositions, containing

a) a thermoplastic material and

b) a multi-layered pigment consisting of a substrate in the core, a first overlying layer of titanium dioxide, a second overlying layer of silicon dioxide and a third overlying layer of titanium dioxide.

The object of the invention is also achieved by articles containing the compositions according to the invention.

The multi-layered pigments according to the invention are commercially available, for example, under the trade name Iriodin® AC 870 from Merck KGBA, Darmstadt, Germany.

The preparation of these pigments is described, for example, in DE-A 19 618 569.

The compositions according to the invention contain preferably 1 to 40 wt. % of the pigments according to the invention.

The substrate of the pigments according to the invention is preferably selected from among mica, layer silicates, small pieces of glass, PbCO₃×Pb(OH)₂, BiOCl (bismuth oxychloride) and flakes of silicon dioxide. In a further preferred form of embodiment the substrate is transparent.

Mica is particularly preferred.

The multi-layered pigment according to the invention is preferably leaf-like in shape. Its particle size is preferably such that the length of the leaves is preferably from 1 to 10 μm.

The multi-layered pigment according to the invention may also have more than three covering layers above the substrate. There may also be other covering layers between the above-mentioned covering layers of titanium dioxide, silicon dioxide and titanium dioxide.

The thicknesses of the layers of the multi-layered pigment according to the invention are preferably as follows:

The first titanium dioxide layer, which lies above the substrate, has a thickness of 100 to 180 nm, in particular 110 to 120 nm. The second, overlying layer of silicon dioxide has a thickness preferably of 100 to 150 nm, in particular 110 to 140 nm. The third, overlying layer of titanium dioxide has a thickness preferably of 110 to 160 nm, in particular 120 to 150 nm.

The multi-layered pigment according to the invention can also be constituted in such a way that, instead of the layers of titanium dioxide, layers of other metal oxides having a higher refractive index are used. Apart from titanium dioxide, these can be, for example: zirconium dioxide, iron(III) oxide, iron(II,III) oxide, chromium trioxide or zinc oxide or iron titanates, hydrated iron oxides or titanium suboxides or mixtures or mixed phases of these compounds with one another or with other metal oxides.

The multi-layered pigment according to the invention can be constituted in such a way that, instead of the layer of silicon dioxide, a layer of another metal oxide having a lower refractive index is used. Apart from silicon dioxide, this may be, for example, aluminium oxide, hydrated aluminium oxide, boron oxide or a mixture of these. The oxide layer having the lower refractive index may also contain alkali metal oxides and alkaline-earth oxides as components.

As the conventional pigments and the pigments to be used according to the invention have a similar structure and both pigments contain titanium dioxide on the outside, it was not obvious to use the pigments according to the invention, primarily because these are more difficult to prepare and are therefore more costly.

Preferred thermoplastic materials according to the invention are those selected from among polycarbonate, polymethyl methacrylate, polystyrene, polysulfone, styrene-acrylonitrile copolymers, polyester, polyether sulfone, polyethylene, polypropylene and mixtures of the above-mentioned polymers.

Polycarbonate is particularly preferred.

A particularly preferred polycarbonate is bisphenol A homopolycarbonate.

Another particularly preferred polycarbonate is the copolycarbonate based on bisphenol A and 1,1-bis(4-hydroxyphenyl)-3,3,5-trirethylcyclohexane.

Other preferred thermoplastic materials are polyacrylates or copolyacrylates and polymethacrylates or copolymethacrylates, for example, polymethyl methacrylate or copolymethyl methacrylate.

Thermoplastic materials which are also preferred are copolymers with styrene such as, for example, transparent polystyrene-acrylonitrile (SAN).

Thermoplastic materials which are also preferred are transparent cycloolefins and polycondensates or copolycondensates of terephthalic acid such as, for example, polyethylene terephthalate (PET) or copolyethylene terephthalate (coPET) or PETG.

Thermoplastic aromatic polycarbonates for the compositions according to the invention are those which have been used hitherto for this purpose. These are homopolycarbonates, copolycarbonates and thermoplastic polyester carbonates. They have a weight average molar mass \overline{M}_{w} of preferably 18,000 g/mol to 40,000 g/mol, more preferably of 20,000 to 36,000 and in particular of 22,000 to 35,000, determined by measurement of the relative solution viscosity in dichloromethane or in mixtures of equal quantities by weight of phenol/o-dichlorobenzene, calibrated by light-scattering.

For the production of polycarbonates for the coextrusion moulding compositions according to the invention, reference is made, for example, to Schnell, “Chemistry and Physics of Polycarbonates”, Polymer Reviews, Vol. 9, Interscience Publishers, New York, London, Sydney, 1964, to D.C. PREVORSEK, B. T. DEBONA and Y. KESTEN, Corporate Research Center, Allied Chemical Corporation, Moristown, N.J. 07960, “Synthesis of Poly(ester)carbonate Copolymers” in Journal of Polymer Science, Polymer Chemistry Edition, Vol. 19, 75-90 (1980), to D. Freitag, U. Grigo, P. R. Müller, N. Nouvertne, BAYER A G, “Polycarbonates” in Encyclopedia of Polymer Science and Engineering, Vol. 11, Second Edition, 1988, pages 648-718 and finally, to Dres. U. Grigo, K. Kirchner and P. R. Müller “Polycarbonates” in Becker/Braun, Kunststoff-Handbuch, Volume 3/1, Polycarbonate, Polyacetale, Polyester, Celluloseester, Carl Hanser Verlag, Munich, Vienna, 1992, pages 117-299.

The production is carried out preferably by the phase interface process or by the melt transesterification process and will be described using as the example the phase interface process.

Compounds preferably to be used as starting compounds are bisphenols corresponding to the general formula HO—Z—OH, wherein Z is a divalent organic group having 6 to 30 carbon atoms which contains one or more aromatic groups. Examples of such compounds are bisphenols, which belong to the groups of compounds including the dihydroxydiphenyls, bis(hydroxyphenyl)alkanes, indanebisphenols, bis(hydroxyphenyl)ethers, bis(hydroxyphenyl)sulfones, bis(hydroxyphenyl)ketones and α,α′-bis(hydroxyphenyl)diisopropyl -bis(hydroxyphenyl)diisopropyl benzenes.

Particularly preferred bisphenols, which belong to the above-mentioned groups of compounds, are bisphenol A, tetraalkylbisphenol A, 4,4-(meta-phenylenediisoproply)diphenol (bisphenol M), 4,4-(para-phenylenediisopropl)diphenol, 1,1-bis(4-hydroxyphenyl)-3,3,5-trimethylcyclohexane (BP-TMC) as well as optionally mixtures of these. Homopolycarbonates based on bisphenol A and copolycarbonates based on the monomers bisphenol A and 1,1-bis(4-hydroxyphenyl)-3,3,5-trimethylcyclohexane are particularly preferred. The bisphenol compounds to be used according to the invention are reacted with compounds of carbonic acid, in particular phosgene or, in the melt transesterification process, diphenyl carbonate or dimethyl carbonate.

Polyester carbonates are obtained by the reaction of the bisphenols already mentioned, of at least one aromatic dicarboxylic acid and optionally carbonic acid equivalents. Examples of suitable aromatic dicarboxylic acids are phthalic acid, terephthalic acid, isophthalic acid, 3,3′- or 4,4′-diphenyldicarboxylic acid and benzophenonedicarboxylic acids. A proportion, up to 80 mol %, preferably from 20 to 50 mol %, of the carbonate groups in the polycarbonates can be replaced by aromatic dicarboxylic ester groups.

Inert organic solvents used in the phase interface process are, for example, dichloromethane, the various dichloroethanes and chloropropane compounds, tetrachloromethane, trichloromethane, chlorobenzene and chlorotoluene; it is preferable to use chlorobenzene or dichloromethane or mixtures of dichloromethane and chlorobenzene.

The phase interface reaction can be accelerated by catalysts such as tertiary amines, in particular N-alkylpiperidines or onium salts. Preferably tributylamine, triethylamine and N-ethylpiperidine are used. In the case of the melt transesterification process, the catalysts mentioned in DE 42 38 123 are used.

The polycarbonates can be branched in a planned and controlled manner by using small quantities of branching agents. Some suitable branching agents are: phloroglucinol, 4,6-dimethyl-2,4,6-tri(4-hydroxyphenyl)-2-heptene; 4,6-dimethyl-2,4,6-tri(4-hydroxyphenyl)heptane; 1,3,5-tri(4-hydroxyphenyl)benzene; 1,1,1-tri(4-hydroxyphenyl)ethane; tri(4-hydroxyphenyl)phenylmethane; 2,2-bis[4,4-bis(4-hydroxyphenyl)cyclohexyl]propane; 2,4-bis(4-hydroxyphenylisopropyl)phenol; 2,6-bis(2-hydroxy-5′-methylbenzyl)-4-methylphenol; 2-(4-hydroxyphenyl)-2(2,4-dihydroxyphenyl)propane; hexa(4-(4-hydroxy-phenylisopropyl)phenyl)orthoterephthalic ester; tetra(4-hydroxyphenyl)methane; tetra(4-(4-hydroxyphenylisopropyl)phenoxy)methane; α,α′,α″-tris(4-hydroxyphenyl)-1,3,5-triisopropylbenzene; 2,4-dihydroxybenzoic acid; cyanuric chloride; 3,3-bis(3-methyl-4-hydroxyphenyl)-2-oxo-2,3-dihydroindole; 1,4-bis(4′,4″-dihydroxytriphenyl)methyl)benzene and in paticular: 1,1,1-tri(4-hydroxyphenyl)ethane and bis(3-methyl-4-hydroxyphenyl)-2-oxo-2,3-dihydroindole.

The optionally concomitantly used 0.05 to 2 mol %, based on diphenols used, of branching agents or mixtures of branching agents, can be introduced together with the diphenols but may also be added at a later stage of the synthesis.

The compounds used as chain stoppers are preferably phenols, such as phenol; alkylphenols, such as cresol and 4-tert. butylphenol, chlorophenol, bromophenol, cumylphenol or mixtures of these in quantities of 1 to 20 mol %, preferably 2 to 10 mol %, per mol bisphenol. Phenol, 4-tert. butylphenol or cumylphenol are preferred.

Chain stoppers and branching agents maybe added to the synthesis separately or else together with the bisphenol.

The production by the melt transesterification process of the polycarbonates for the compositions according to the invention is described, for example, in DE 42 38 123.

In a preferred embodiment of the present invention, the compositions according to the invention contain UV absorbers. The composition according to the invention contains the UV absorbers in a quantity preferably of 0.1 to 10 wt. %, particularly preferably 3 to 8 wt. %.

The UV absorber according to the invention is preferably a UV absorber selected from among bis[2-hydroxy-5-tert.-octyl-3-(benzotriazol-2-yl)phenyl]methane, 2-(4,6-diphenyl-s-triazin-2-yl)-5-hexyloxyphenol and bis[2-hydroxy-5-tert.-octyl-3-(benzotriazol-2-yl)phenyl]methane and 2-(4,6-diphenyl-s-triazin-2-yl)-5-hexyloxyphenol).

The UV absorbers are incorporated into the compositions according to the invention by conventional methods, for example, by mixing together solutions of the UV absorbers with solutions of the plastics in suitable organic solvents such as CH₂Cl₂, haloalkanes, haloaromatics, chlorobenzene and xylenes. The mixtures of solids are then homogenised in known manner, for example, by extrusion; the mixtures of solutions are removed in known manner by evaporation of the solvent and subsequent extrusion.

Suitable UV absorbers for the optionally used coextrusion compositions are those compounds which, owing to their absorptive power of below 400 nm, are capable of effectively protecting polycarbonate from UV light, and which have a molecular weight of more than 370, preferably of 500 and above.

Suitable UV absorbers are in particular the compounds corresponding to formula (II), which are described in WO 99/05205

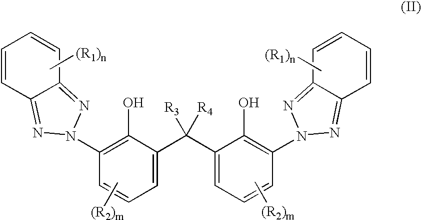

wherein

R¹ and R² are identical or different and denote H, halogen, C₁-C₁₀-alkyl, C₅-C₁₀-cycloalkyl, C₇-C₁₃-aralkyl, C₆-C₁₄-aryl, —OR⁵ or —(CO)—O—R⁵,

with R⁵=H or C₁-C₄-alkyl,

R³ and R⁴ are likewise identical or different and denote H, C₁-C₄-alkyl, C₅-C₆-cycloalkyl, benzyl or C₆-C₁₄-aryl,

m equals 1, 2 or 3 and

n equals 1, 2, 3 or 4,

as well as those corresponding to formula (III)

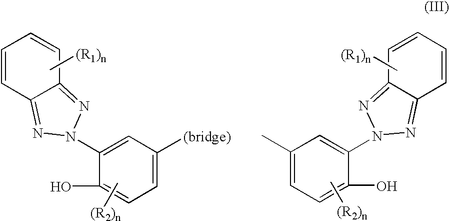

wherein the bridge denotes

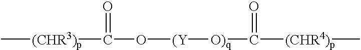

and

R¹, R², m and n have the meanings given for formula (II), and

wherein in addition p is an integer from 0 to 3,

q is an integer from 1 to 10,

Y denotes —CH₂—CH₂—, —(CH₂)₃—, —(CH₂)₄—, —(CH₂)₅—, —(CH₂)₆—, or is CH(CH₃)—CH₂— and

R³ and R⁴ have the meanings given for formula (II).

Other suitable UV absorbers are substituted triazines, such as 2,4-bis(2,4-dimethylphenl)-6(2-hydroxy4-n-octyloxyphenyl)-1,3,5-triazine (CYASORB® UV-1164) or 2-(4,6-diphenyl-1,3,5-triazin-2-yl)-5-(hexyl)oxyphenol (Tinuvin® 1577). A particularly preferred UV absorber is 2,2-methylenebis(4-(1,1,3,3-tetramethylbutyl)-6-(2H-benzotriazol-2-yl)phenol), which is sold commercially under the trade name Tinuvin® 360 or Adeka Stabs® LA 31. The UV absorbers mentioned in EP 0 500 496 A1 are also suitable. The UV absorber Uvinol 3030, from BASF AG, which is obtained in Example 1 of WO 96/15102, can also be used.

Suitable stabilisers for the polycarbonates for the compositions according to the invention are, for example, phosphines, phosphites or epoxides or Si-containing stabilisers and other compounds described in EP-A 0 500 496 and in U.S. Pat. No. 3,673,146. Examples which may be mentioned are triphenylphosphines, diphenylalkyl phosphites, phenyldialkyl phosphites, tris(nonylphenyl) phosphite, tetrakis-(2,4-di-tert.-butylphenyl)-4,4′-biphenylene diphosphonite and triaryl phosphite. Triphenylphosphine and tris(2,4-di-tert.-butylphenyl) phosphite are particularly preferred.

The compositions according to the invention can be used for the coextrusion of sheets. These sheets can be provided on one or both sides with coextrusion layers. The sheets can be in particular solid sheets, multi-wall sheets, corrugated solid sheets or corrugated multi-wall sheets.

Coextrusion as such is known in the literature (see, for example, EP-A 0 110 221 and EP-A 0 110 238).

Examples of antistatic agents, which can be contained in the compositions according to the invention, are cationic compounds, for example, quaternary ammonium, phosphonium or sulfonium salts; anionic compounds, for example, alkyl sulfonates, alkyl sulfates, alkyl phosphates, carboxylates in the form of alkali metal salts or alkaline-earth metal salts; non-ionising compounds, for example, polyethylene glycol esters, polyethylene glycol ethers, fatty acid esters, ethoxylated fatty amines. Preferred antistatic agents are non-ionising compounds.

Preferred fillers, which can be contained in the compositions according to the invention, are glass fibres, mica, silicates, quartz, talc, titanium dioxide or wollastonite. Preferred reinforcing agents are glass fibres or carbon fibres.

All the feed materials and solvents used for the synthesis of the compositions according to the invention may be contaminated with corresponding impurities from their production and storage and it is the aim to work with starting materials which are as clean as possible.

The individual components can be mixed together in known manner, either successively or simultaneously, and either at room temperature or at elevated temperature.

The additives are incorporated into the compositions according to the invention in known manner, for example, by mixing polymer granules with the additive(s) and subsequent extrusion or by mixing the solutions of polycarbonate with solutions of the additives and subsequent evaporation of the solvents in known manner. The proportion of additives in the composition can be varied within wide limits and depends upon the required properties of the composition. The total content of additives in the composition may be up to about 40 wt. %, preferably 4 to 30 wt. %, based on the weight of the composition.

The compositions thus obtained can be converted by means of the conventional methods such as, for example, hot pressing, spinning, extrusion or injection moulding, into shaped objects (articles) such as, for example, parts for toys, and also fibres, films, bands, sheets, multi-wall sheets, vessels, tubes and other profiles. The compositions can also be processed to form cast films. The invention accordingly also relates to the use of the compositions according to the invention for the production of a shaped article. The use of multi-layered systems is also of interest.

The articles according to the invention containing the compositions according to the invention are preferably sheets, in particular solid sheets or twin-wall sheets or triple-wall sheets or corrugated sheets or other multi-wall profiles.

The sheets according to the invention also include in particular those having on one side or on both sides an additional top coat containing the composition according to the invention with an increased content of UV absorbers.

The compositions according to the invention permit the production of articles having pearl-like surfaces, such as decorative sheets for wall panelling, partition walls, ceiling panelling, false ceilings, window panes with subdued incidence of light, elements of modern room design, visually appealing facings, layers used as a substitute for coats of paint and for heat insulation.

Subsequent treatments of the articles according to the invention such as, for example, deep drawing or surface treatments such as, for example, finishing with scratch-resistant coatings, water-repellent layers and the like are possible and the articles produced by these processes are likewise the subject matter of this patent.

Preferred articles according to the invention are also those which consist of a core and of a covering layer, the covering layer being the composition according to the invention. The covering layer can be applied to the core, for example, by coextrusion. The core can, for example, be a sheet. These preferred articles can be in particular decorative sheets for wall panelling or partition walls or ceiling panelling or false ceilings or window panes with subdued incidence of light or layers used as a substitute for coats of paint or for heat insulation.

Preferred articles according to the invention are also those articles in which a core is laminated with at least one film consisting of the composition according to the invention. These articles can be in particular decorative sheets for wall panelling or partition walls or ceiling panelling or false ceilings or window panes with subdued incidence of light or layers used as a substitute for coats of paint or for heat insulation.

The invention is explained further by the following Example.

### EXAMPLE1

10 mm twin-wall sheets A, B, C and D, of the type described, for example, in EP-A 0 110 238, were obtained from the following compositions: Makrolone® KU 1-1243 (branched bisphenol A polycarbonate from Bayer A G, Leverkusen) was used as the base material. This was coextruded with the compounds based on Makrolon® 3108 (linear bisphenol A polycarbonate from Bayer A G, Leverkusen) given in the Table.

The thickness of the coextrusion layer was about 50 μm in each case.

The machines and apparatus used for producing multi-layered multi-wall sheets are described below:

The equipment consisted of

the main extruder having a screw of 33 D in length and a diameter of 70 mm with degassing

the coex adaptor (feed block system)

a coextruder for applying the top coat, having a screw of 25 D in length and a diameter of 30 mm

the special slot die having a width of 350 mm

the calibrator

the gravity-roller conveyor

the discharging device

the device for cutting to length (saw)

the delivery table.

The polycarbonate granules of the base material were passed to the feeding hopper of the main extruder and the UV coextrusion material was passed to that of the coextruder. The melting and conveyance of the respective material took place in the respective plasticising system cylinder/screw. The two melted materials were introduced together into the coex adaptor and formed a laminate subsequent to leaving the die and being cooled in the calibrator. The other devices served to transport, cut to length and deliver the extruded sheets.

The sheets obtained then underwent a colorimetric valuation. Here the following measurement techniques were used.

1. Transmission (based on the Standards ASTM E 308/ASTM D 1003) Equipment: Pye Unicam (geometry of measurement: 0°/diffuse, calculated from illuminant C)

2. Yellowness Index, as instructed in ASTM D 1003, using a Haze-Gard plus apparatus from BYK-Gardner GmbH, D-82538 Geretsried.

3. These plates were weathered in the Weather-o-meter from Atlas, USA, using a 6.5 W xenon burner, with a cycle of 102 min. exposure to light and 18 min. spraying with demineralised water during exposure to light. The maximum black table temperature was 60° C. (±5° C.).

Coextrusion moulding compositions having the following formulations based on Makrolon® 3108 were prepared:

| No. | UV absorber | Pigment |
|---|---|---|
| A | 5% Tinuvin 360 | 10% conventional pigment¹⁾ |
| B | 5% Tinuvin 360 | 10% conventional pigment²⁾ |
| C | 5% Tinuvin 360 | 10% pigment according to the invention³⁾ |
| D | 5% Tinuvin 360 | 20% pigment according to the invention³⁾ |

¹⁾Magna Pearl 1000 from Costenoble GmbH, Eschborn, Germany
²⁾Magna Pearl 1110 from Costenoble GmbH, Eschborn, Germany
³⁾Iriodin AC 870 from Merck KGaA, Darmstadt, Germany

### Example 1

Development of the Yellowness Indices during Artificial Weathering

| | Yellowness Index | Yellowness Index | |
|---|---|---|---|
| No. | (0 hours) | (2100 hours) | Difference |
| A | 23.4 | 29.6 | 6.2 |
| B | 15.2 | 19.2 | 4.0 |
| C | 9.2 | 9.8 | 0.6 |
| D | 16.2 | 14.0 | −2.2 |

Example 1 shows that the pigments according to the invention exhibit a significantly better colour stability during artificial weathering than do the conventional pigments.
Pigments based on a substrate which is coated only with titanium dioxide do not exhibit an adequate colour constancy during weathering, as Example 1 shows.

1. Composition, containing
a) a thermoplastic material and
b) a multi-layered pigment consisting of a substrate in the core, a first overlying layer consisting of a metal oxide having a high refractive index, a second overlying layer consisting of a metal oxide having a low refractive index and a third overlying layer consisting of a metal oxide having a high refractive index.

2. Composition, containing
a) a thermoplastic material and
b) a multi-layered pigment consisting of a substrate in the core, a first overlying layer of titanium dioxide, a second overlying layer of silicon dioxide and a third overlying layer of titanium dioxide.

3. Composition according to claim 1 or 2, wherein the thermoplastic material is selected from among polycarbonate, polymethyl methacrylate, polystyrene, polysulfone, styrene-acrylonitrile copolymers, polyester, co-polyester, polyether sulfone, polyethylene, polypropylene and mixtures of the above-mentioned polymers.

4. Composition according to claim 1 or 2, wherein the thermoplastic material is polycarbonate.

5. Composition according to any one of claims 1 to 4, wherein the substrate of the pigment is mica.

6. Composition according to any one of claims 1 to 5, wherein the composition contains 1 to 40 wt. % of the multi-layered pigment.

7. Composition according to any one of claims 1 to 6, which contains in addition UV absorbers.

8. Composition according to claim 7, wherein the UV absorber is selected from among bis[2-hydroxy-5-tert.-octyl-3-(benzotriazol-2-yl)phenyl]methane, 2-(4,6-diphenyl-s-triazin-2-yl)-5-hexyloxyphenol and bis[2-hydroxy-5-tert.-octyl-3-(benzotriazol-2-yl)phenyl]methane and 2-(4,6-diphenyl-s-triazin-2-yl)-5-hexyloxyphenol).

9. Process for the production of articles made of compositions according to any one of claims 1 to 8 by extrusion or coextrusion or injection moulding.

10. Articles containing compositions according to any one of claims 1 to 8.

11. Article according to claim 10, wherein the article is selected from among single-layered solid sheets, multi-layered solid sheets, single-layered multi-wall sheets, multi-layered multi-wall sheets, single-layered corrugated sheets, multi-layered corrugated sheets, roofing and window panes.

12. Multi-layered sheet containing a base layer containing a thermoplastic material, in particular polycarbonate or PETG and one or two outer layers containing a composition according to any one of claims 1 to 8.
